(19) United States
(12) Patent Application Publication
(10) Pub. No.: US 2017/0006444 A1
(43) Pub. Date: Jan. 5, 2017

(54) INTELLIGENT INDEPENDENT CALL SERVER

(71) Applicant: Kent S. Charugundla, New York, NY (US)

(72) Inventor: Kent S. Charugundla, New York, NY (US)

(21) Appl. No.: 14/790,799

(22) Filed: Jul. 2, 2015

(51) Int. Cl. H04W 4/16; H04M 3/42; H04M 3/56; H04W 24/08; H04W 4/14

(52) U.S. Cl. CPC H04W 4/16; H04W 24/08; H04W 4/14; H04M 3/56; H04M 3/42221

(57) ABSTRACT

An Intelligent Independent Call Server (IICS) is coupled to communication equipment of a network that signals the IICS of an established telephone call during which the IICS provides additional features to communication equipment of parties to the established telephone who are subscribers to the services being provided by the IICS. The services being provided by the IICS comprise various telephone call features that can be requested by parties to the established telephone call who have subscribed to such features. Subscriber parties to the telephone call request for specific features during the telephone call by dialing, on their communication devices, certain IICS defined sequences of DTMF keys which when recognized by the IICS causes it to execute the corresponding feature.

### BACKGROUND

Field of the Disclosure

The present disclosure generally relates to communication networks and in particular to an independent server providing additional features to subscribers of communication networks.

Description of Related Art

This section is a discussion intended to provide a better understanding of the disclosure herein, but makes no claim nor implies as to what is the relevant prior art for this disclosure.

The development of the cellular networks has progressed to such an extent where certain features such as call conferencing, SMS (Short Messaging Service), and caller id have become standard features provided by the network operators. As more and more features become accepted as standard features, network operators have to constantly update their systems and therefore incur higher operations costs. In many cases the updating requires the procurement of new equipment to provide these features that are expected by their subscribers.

### SUMMARY

This summary is provided as a disclosure of some embodiments of an Intelligent Independent Call Sever (IICS) discussed herein. These embodiments and others are described below in the Detailed Description. This summary is not intended to identify key features or essential features of the claimed subject matter, nor is this summary intended as an aid in determining the scope of the claimed subject matter.

Disclosed herein are various embodiments of an apparatus and a method. In one embodiment, the IICS apparatus of this disclosure comprises at least one transceiver; at least one memory circuit; and at least one processor coupled to the at least one transceiver and the at least one memory circuit, whereupon the apparatus receiving access to an established telephone call, the at least one processor executes automatically one or more commencement telephone call features based on selected features associated with the telephone call and the processor monitors transmitted signals from the established telephone call to execute non-conflicting telephone call features in response to received feature requests.

In one embodiment of the apparatus of the present disclosure access to the established telephone call is received via a loopback configuration.

In another embodiment of the apparatus of the present disclosure the conflicting and non-conflicting features are defined by a data structure stored in the memory circuit.

In yet another embodiment of the apparatus of the present disclosure the telephone call feature requests received from a non-subscriber mobile terminal are filtered out by the processor.

In yet another embodiment of the apparatus of the present disclosure conflicting telephone call feature requests received from a subscriber mobile terminal are filtered out by the processor.

In yet another embodiment of the apparatus of the present disclosure the processor isolates transmitted signals and received signals received from subscriber mobile terminals.

In yet another embodiment of the apparatus of the present disclosure the processor monitors the isolated transmitted signals to determine whether a telephone call feature request was transmitted.

In yet another embodiment of the apparatus of the present disclosure the feature request is a string of DTMF signals received from a subscriber mobile terminal.

In yet another embodiment of the apparatus of the present disclosure the automatic telephone call feature is a PBX feature.

In yet another embodiment of the apparatus of the present disclosure the automatic telephone call feature is call broadcasting.

In yet another embodiment of the apparatus of the present disclosure the non-conflicting telephone call feature is an automatic call distribution.

In yet another embodiment of the apparatus of the present disclosure the non-conflicting telephone call feature is SMS logging.

In yet another embodiment of the apparatus of the present disclosure the non-conflicting telephone call feature is a telephone call conferencing.

In yet another embodiment of the apparatus of the present disclosure the non-conflicting telephone call feature is telephone call recording.

In yet another embodiment of the apparatus of the present disclosure the non-conflicting telephone call feature is call whisper.

In yet another embodiment of the apparatus of the present disclosure the non-conflicting telephone call feature is call barging.

In yet another embodiment of the apparatus of the present disclosure the non-conflicting telephone call feature is log on and log off documentation.

In yet another embodiment of the apparatus of the present disclosure the apparatus further comprises a cloud storage system coupled to the at least one memory.

In yet another embodiment of the apparatus of the present disclosure a portion of the cloud storage system includes a portal accessible via a public network and through which users subscribe to services provides by the apparatus.

In yet another embodiment of the apparatus of the present disclosure the public network is the Internet.

In yet another embodiment of the apparatus of the present disclosure a portion of the cloud storage includes a portal accessible via a public network and further where previously entered subscriber information are updated by said subscribers.

In yet another embodiment of the apparatus of the present disclosure the apparatus further comprises a communication switch.

In yet another embodiment of the apparatus of the present disclosure the communication switch routes the established telephone call from an interconnected network to a non-interconnected network.

In yet another embodiment of the apparatus of the present disclosure the established telephone call is routed via the Internet.

One embodiment of the method of the present disclosure comprises the steps of monitoring, by an IICS, for received transmit signals of an established communication session to determine if at least one feature request has been transmitted; and executing the at least one requested feature after confirming that said requested feature is non-conflicting.

In another embodiment of the method of the present disclosure the step of monitoring comprises receiving, by the IICS, an established call signal and determining, by the IICS, whether at least one of the parties to the established call is a subscriber to services provided by the IICS.

In yet another embodiment of the method of the present disclosure the established communication session is an established telephone call.

In yet another embodiment of the method of the present disclosure the IICS isolates transmit signals of each party to the communication session and the IICS also isolates signals received by each party to the communication session.

In yet another embodiment of the method of the present disclosure the received signals are from communication equipment of a communication network to which IICS is coupled.

In yet another embodiment of the method of the present disclosure the communication network is an interconnected communication network.

In yet another embodiment of the method of the present disclosure the IICS is coupled to the communication network via a loopback connection.

In yet another embodiment of the method of the present disclosure the received transmit signals monitored for by the IICS are keyed sequences of DTMF tones of a communication equipment of an IICS subscriber.

In yet another embodiment of the method of the present disclosure the step of executing the at least one feature comprises executing a commencement feature.

In yet another embodiment of the method of the present disclosure the step of monitoring by the IICS comprises first determining whether there are commencement features and executing automatically any found commencement.

### BRIEF DESCRIPTION OF THE DRAWINGS

The understanding of the present disclosure and its numerous features and advantages are facilitated for those skilled in the relevant art of this disclosure by referring to the accompanying drawings. Reference numerals and/or symbols are used in the drawings. The use of the same reference in different drawings indicates similar or identical components, devices or systems. Various other aspects of this disclosure, its benefits and advantages may be better understood from the Detailed Description herein and the accompanying drawings described as follows:

FIG. 1 shows the system of the present disclosure coupled to different types of communication networks.

FIG. 2 depicts a flow chart of the operation of the system of the present disclosure.

FIG. 3 shows a block diagram of device or system of the present disclosure

### DETAILED DESCRIPTION

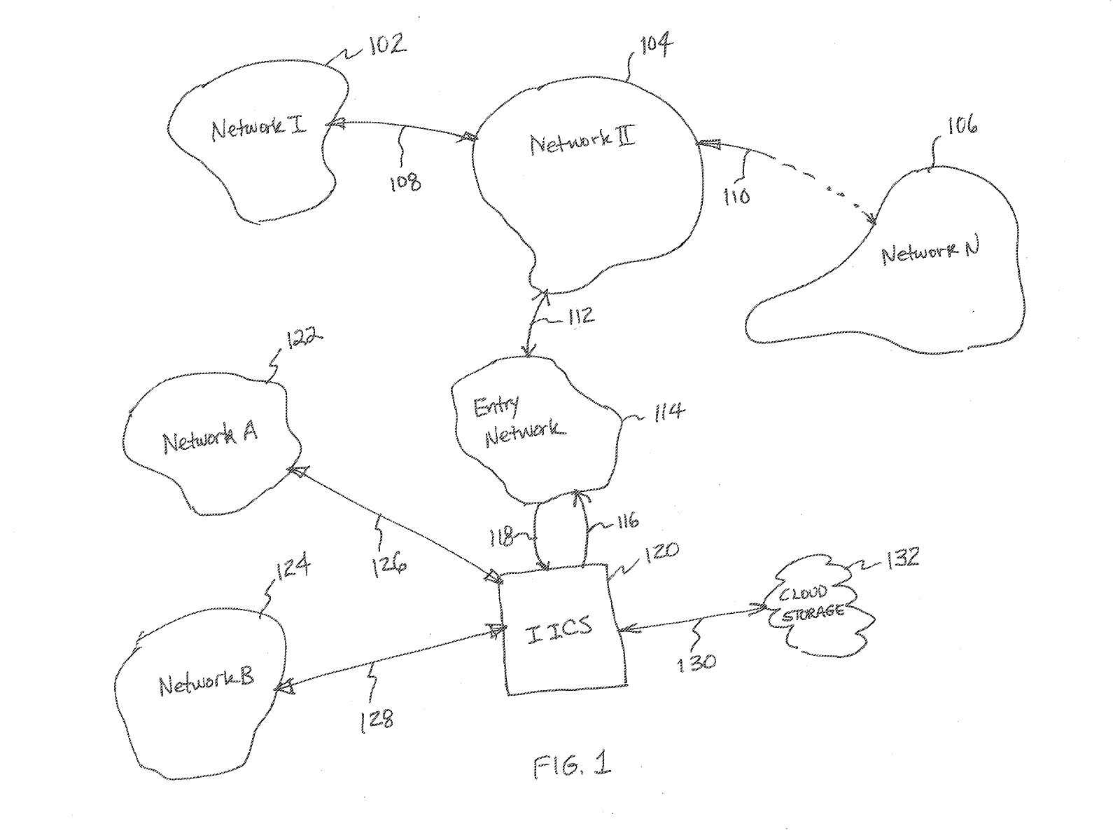

Referring to FIG. 1, there is shown the system of the present disclosure coupled to various types of communication networks. One embodiment of the system of the present disclosure is shown as IICS (Intelligent Independent Call Server) system or device 120 shown coupled to several interconnected networks (i.e., networks 102, 104, 106, and 114) via respective communication links 108, 110, and 112. Each of the communication links (108, 110, 112) is shown as one continuous link or connection between two different networks. It should be noted however that each of the communication links may comprise various communication equipment that facilitate the transmission and reception (or both transmission and reception simultaneously or at different times) of communication signals between the different networks. Further, the communication links may be implemented with various media including but not limited to copper wire, coaxial cables, satellite communication channels, optical fiber links, microwave links, or any combination thereof.

The interconnected networks may be wireless communication networks, public digital networks (e.g., the Internet), legacy telephone networks (e.g., POTS (Plain Old Telephone System) and PSTN (Public Switched Telephone Network)), Voice over Internet Protocol or Voice over IP (VoIP) networks and other well-known communication networks. The interconnected networks provide services to users of such networks who are able to receive the services at any physical location being served by any of the interconnected networks. An interconnected network refers to a first communication network coupled (via a communication link) to at least a second communication network where a user of the first communication is allowed to use resources of the second communication network when the communication networks are establishing a communication session (e.g., a telephone call, various types of text messaging) and maintaining such a communication session. A communication session is the exchange of signals between at least two subscriber communication equipment (e.g., mobile terminal, IP (Internet Protocol) telephone) for a period of time during which the communication signals are transmitted and received in accordance with a protocol or protocols of one or more communication standard being followed by the network or networks through which the signals are conveyed and by the subscriber communication equipment. The establishment of a communication and more particularly, the establishment of a telephone call refers to the various steps performed by communication equipment (e.g., a communication switch, a Message switching center, a communication server) of one or more networks in accordance with various communication protocols of one or more communication standards. Once a communication session (e.g., voice telephone call) is established the communication equipment involved in such establishment can confirm with each other that the call has been established and the users can start to communicate with each other. Communication equipment inform each other that at their end communications have been established using established signaling procedures that are part of the communication protocols. The established communication session (e.g., a telephone call) can then be routed between various equipment of one or more interconnected networks.

Various telecommunications features, which may not be provided by a communication network, can be provided by IICS system or device 120 to users who have subscribed to such features through a particular interconnected network; thus any such features are hereinafter referred to as a telephone call feature. It should be noted that a telephone call feature is not limited to ‘telephone calls’ in the traditional sense. A telephone call feature involves established calls for conveying voice, data, text, video, and other well-known signals that are transmitted or received or—transmitted and received—during a communication session. A communication session is a certain period of time wherein at least one calling party and at least one called party A telephone call feature refers to a capability provided by a network to its subscriber that is in addition to the capability of transmitting and receiving information carrying signals where such feature can be invoked by a subscriber during an established telephone call or at the commencement of a call that has already been established or as part of the termination of an established telephone call. The term ‘telephone call’ as used herein is a communication session between at least two communication devices operated by users of such devices to convey information in accordance with protocols of one or more communication standards for a definite period of time. A telephone call has been established when the called party receives a ring signal causing his/her equipment to ring indicating that a calling party wishes to commence communications. Well-known examples of telephone call features include, but are not limited to, call forwarding, caller id and call waiting. IICS 120 when coupled to an interconnected network such as network 114 is able to provide additional telephone call features to users of network 114 by allowing such users to register for said features at a portal owned and controlled by IICS 120. Such a portal can be a web site on the Internet at which subscribers to network 114 can register for various features being offered by IICS 120. The web site can be in communication with a cloud storage system at which information associated with subscribers to the IICS system or device are stored. The web site can be part of the cloud storage that allows access to subscribers desiring to update their information or allows access to users wanting to subscribe to the services being offered by IICS 120. The portal (e.g., publicly available web site) may be part of a system of servers (controlling relatively large amounts of memory) that communicate with each other to form cloud storage system 132; thus the portal may reside in the cloud storage system.

A user or subscriber can enter their user login and password to gain access to their information or enter user profile information and identify the particular telephone call features to which they wish to subscribe. The term ‘User profile information’ refers to information that uniquely identifies a user. Such information as a user email address, home address, telephone number, credit card information are examples of user profile information. A user who has entered his/her user profile information via the portal and has entered into an agreement with network 114 to be provided with the additional features of the system or device 120 is hereinafter referred to as a subscriber. In other embodiments, IICS 120 may contain communication equipment that enables it to provide communication services to users, viz., the same type of communication services network 114 provides. Such a user may enter into an agreement for services with IICS apparatus or system 120 and not a network. Further, IICS system or device may be part of its own communication network, i.e., a communication network owned and operated by the owners and operators of IICS apparatus or system 120.

Continuing with the description of FIG. 1, network 114 is an interconnected network to which IICS apparatus or system 120 is providing additional telephone call features to subscribers of network 114. Subscribers of network 114 can subscribe to these additional call features at a portal (as described above) owned and operated by IICS owners who are not necessarily owners and operators of network 114. The owners and operators of network 114 may direct their subscribers to the portal to allow said subscribers to subscribe to these additional services without knowing that these additional services are actually being provided by a separate system coupled to network 114. In other embodiments of this disclosure, IICS 120 may be integrated into network 114 and become part of network 114. Further for such an embodiment, IICS apparatus (or system 120) can be, owned, for example, by the owners of network 114. IICS apparatus or device 120 is shown coupled to network 114 via communication links 116 and 118.

IICS apparatus or device 120 receives communication signals from network 114 via communication link 118. IICS apparatus or system 120 transmits communication signals to network 114 via communication link 116. The constitution of communication links 116 and 118 may be similar to or substantially exactly like the constitution of communication links 108, 110 and 112 as described above. Network 114 is referred to an Entry network because it allows IICS 120 to gain access to other interconnected networks (i.e., network 102, 104 and 106) via network 114 and allows subscribers of IICS located within other interconnected networks to have access to IICS and the telephone call features it provides. Moreover, subscribers of network 114 who are accessing network 114 via one of the other interconnected networks will still be able to receive the additional features being provided by IICS 120. An established call is routed from communication equipment (e.g., a communication switch) of network 114 in loopback fashion; this means that the call is routed through IICS (which perform any necessary processing—such as telephone call features) via communication link 118 and routed back to network 114 via communication link 116 to its destination. IICS 120 adds information to the call and alters the processing of the call consistent with a telephone call feature (if any) being performed by IICS 120.

IICS apparatus or system 120 has the capability to isolate the transmit signals of the calling party and the called party as signals of an established telephone call are being routed and looped back through the IICS. IICS 120 loops back telephone calls—once established—and processes such calls using well-known techniques to maintain acceptable quality of service and quality of experience levels for the parties of the telephone call. Part of the processing performed by the IICS 120 involves adding new signals to the signals being routed and routing the aggregate signals through various equipment to perform various steps in response to feature requests (automatic or non-conflicting or both) by at least one of the parties to the telephone call. The term ‘loop back’ refers to IICS 120 receiving the signals (information or data carrying signals and signaling information) of a telephone call over link 118 for example, processing said signals as described above and routing said processed signals via link 116 back to network 114. The information carrying signals prior to being looped back are isolated into calling party transmission signals, calling party reception signals, called party transmission signals and called party reception signals by IICS 120. The isolation of signals being transmitted by different parties to an established telephone call is a well-known process and for efficiency of discussion will not be discussed here in any detail. Having this ability to isolate transmit signals from received signals of each of the parties of an established telephone call allows IICS 120 to monitor whether any of the parties is transmitting a feature request during the call. Also, the transmit signals are not only isolated from received signals, but they are isolated from other transmit signals. With the isolation of transmission signals from each of the parties of a telephone call (or more generally a communication session), IICS 120 is better able to monitor the signals (voice, data, DTMF tones, video, text, multimedia) being transmitted by each party. An established telephone call results from one or more procedures by which at least one calling party and at least one called party, initiate communications between each other and successfully confirm acceptable conveyance of information between each other users of the same or different networks where the initiation of communications and the confirmation of communications are dictated by one or more protocols of one or more communication standards being followed by the networks involved. A call is established once the called party's telephone rings indicating that a calling party wishes to communicate with the called party. The establishment of a telephone is also considered complete when the equipment (e.g., a communication switch) establishing the call has performed all of the steps called out by the pertinent protocol(s) and the communication equipment is ready to send a ring signal to the called party. Further, establishment of a call can be said to completed when the called party goes off hook (i.e., answers the call) upon receiving a ring signal. A communication session refers to the amount of time an established call lapsed from the beginning of the call until it is terminated by one of the parties to the call. A communication session may also be ended by unforeseen or unknown circumstances that cause the termination of communication between the parties to an established telephone call.

Each party to a phone call has a separate transmit channel and a separate receive channel. That is, for an established call, the IICS 120 is able to isolate, in well known fashion, the transmissions of each party to the established telephone call and also isolate the signals being received by each party to the telephone call. This allows the IICS 120 (and in particular, the processor of the IICS) to monitor each such channel for certain types of signals transmitted by one or both of the parties to the telephone call. For this disclosure, each transmit channel (through which transmit signals of a party to an established telephone call are conveyed) is monitored for any telephone call feature requests generated by a communication device of a party. Such feature requests are generated by communication equipment (e.g., a mobile terminal) whose dial pad is touched or dialed by a party (of an established telephone call, for example) touching a sequence of numbers or symbols of a standard telephone dial pad during an established telephone call. As is well known each of the various alphanumeric keys, when touched (or dialed) on a dial pad generate two specific tones; this well known convention is known as DTMF (Dual Tone Multi-Frequency) dialing.

The IICS can define different DTMF sequences to represent different telephone call feature requests or commands that are transmitted by communication equipment (e.g., mobile terminal or cellular telephone) during an established telephone call. A subscriber of IICS 120 can press a certain sequence of touch keys of the dial pad (also called a “touchpad”) during an established communication session such as a telephone call. The IICS will detect the resulting generated touch tone signals and attempt to match the signal to a defined telephone call feature request or command stored in its memory or in cloud storage 132. Each telephone call feature is defined by IICS 120 and categorized by IICS 120. For example, the IICS may have telephone call features categorized as ‘automatic’ features, and other features categorized as ‘non-conflicting features.

Automatic telephone call features are features that are executed by IICS 120 based on conditions detected by IICS 120 and are automatically executed based on the occurrence of certain conditions or set of conditions. The IICS defines the set of conditions under which it will execute automatic features. One example of such a condition is a feature that is necessary for actual communication between parties avoiding gaps in communications between the parties or avoiding communication signals impaired to an extent that causes at least one of the parties to receive distorted or incomplete information is where a hard of hearing subscriber (or a subscriber who is deaf) will have listed text transcription of audio signals received by his/her equipment during a telephone call as one of the features he/she desires. Such a condition, in order to have meaningful and complete communication between the parties is met only when the transcription feature is executed at the beginning of the communication session between the parties. These automatic features are executed by IICS 120 when it detects circumstances that under which execution of such features is acceptable. Automatic features can occur at the beginning of an established telephone call; such features that occur at the beginning of the telephone call (i.e., a communication session) are referred to as commencement features. Thus, in many cases, telephone call commencement features are performed automatically by the IICS 120, but such features are not necessarily automatic. In other words, a telephone call commencement feature is not executed in response to the IICS receiving a telephone call feature request transmitted from a subscriber mobile terminal of the telephone call. Rather, a telephone call commencement feature (also referred to as a “commencement feature”) is a feature executed at the beginning of a telephone conversation or immediately after the IICS receives a signal indicating the establishment of a call in which at least one of the parties to the telephone call is a subscriber to the features offered by IICS 120. IICS defines the circumstances under which it decides to execute a commencement feature. The IICS monitors continuously isolated transmit channels of the routed telephone call to enable it to detect telephone call feature requests. Non-conflicting call features are features determined by IICS 120 as not interfering with a set of certain features as defined by IICS 120. Thus, for each non-conflicting feature, there is a list of other features that will not conflict with such non-conflicting feature. For example, suppose for an established telephone call, an automatic feature has already been executed and is being executed on a continuous basis. Suppose further, that at some time later during the established telephone call, IICS 120 detects a feature request transmitted by a subscriber mobile terminal (or telephone) associated with the established telephone call. At this point, IICS 120 determines whether the particular feature that has already been executed or is continuing to be executed is in conflict with the feature being requested. IICS may have a data structure that defines for every particular feature, whether any and all other features are in conflict with such a feature.

If the feature being requested by a party to the established telephone call is in conflict as defined by the IICS 120, with a feature being executed or an already executed feature in the established telephone call, then the feature being requested is not executed and IICS sends a message (e.g., text, synthesized voice, audio tones signaling invalid request) or some type of indicator to the requesting party that the feature being requested is in conflict with the feature already executed or the feature currently being executed for the telephone call. The IICS apparatus or system 120 of the present disclosure has a processor (to be discussed infra) which checks a mapping of all of the features against each other to determine whether a requested feature is in conflict with an already executed feature or a feature currently being executed. If the feature being requested does not conflict with the feature already being executed, then the processor deems that the feature being requested as a non-conflicting telephone call feature and proceeds to execute that feature. The operators and administrators of IICS 120 define the features and the corresponding conflicting feature based on arbitrary criteria. Such criteria may be based on, for example, the difficulty or the impracticality of executing two features within the same established telephone call.

The IICS system or apparatus 120 maps each defined telephone call features requests or commands (generated with the use of the DTMF dial pad) to a telephone call feature data structure comprising automatic features and non-conflicting telephone call features. The features that are available to all subscribers are listed at the portal, which can be visited by all subscribers to IICS apparatus or system 120. Upon visiting a portal and entering user profile information and the various additional telephone call features desired, a user enters into an agreement with a network (e.g., network 114) having IICS 120 coupled thereto or with IICS 120 directly to pay for the telephone call features he/she selected at a portal provided by IICS 120. The portal is a publicly accessible portal such as an Internet website, a 1-800 toll free telephone number or paper applications that can be mailed to the owners of network 114 or the owners of IICS 120 whatever the case may be. The link or website can be part of an app downloaded onto a subscriber's cellular phone (i.e., mobile terminal). At the portal a user is provided with the list of features being provided by IICS 120. Once a subscriber selects the set of features he/she desires, the portal will generate a short spreadsheet showing each of the selected features and their corresponding conflicting features. Such a spreadsheet will be emailed or sent via text to the subscriber.

IICS system or apparatus 120 being coupled to network 114 is able to provide additional telephone features to subscribers of network 114 who can gain access to network 114 directly or gain access to network 114 indirectly via one of the other interconnected networks. In many geographical locations throughout the world, competing (or simply different) communication service providers have agreements between each other to allow access to their networks to subscribers of competing or different networks. The well-known concept of roaming is one implementation of this approach. For example, a subscriber of network 114 who is physically located in an area being serviced by network 104 is given access to network 104 and its communication signals ultimately are processed by network 114. Therefore, all subscribers of network 114 who have subscribed to additional services being provided by IICS 120 will be able to receive such services as long as they have access to any network interconnected with network 114. By definition, interconnected networks provide access to their subscribers and to subscribers of other networks where all such networks are interconnected.

IICS is also coupled to other networks that are not coupled to any of the interconnected networks. Communication networks 122 and 124 are coupled to IICS device or system 120 via communication links 126 and 128 respectively. It should be noted that communication networks 122 and 124 although not ‘interconnected’ to the other networks may still be able to communicate with such networks. However, communication networks 122 and 124 may operate under different governmental jurisdictions or different set of operators that operate under different governmental or geographical jurisdictions. One of the features provided by IICS 120 may be to route a call originating from a subscriber of IICS system or device 120 to another party who is not a subscriber of IICS. IICS 120 may further comprise a communication switch that would enable it to route such a call from network 114 to one of the networks 122 or 124. For example, such a call originating from network 114 may be routed over the Internet by the communication switch of IICS system or device 120. Also as shown, IICS system or device 120 is coupled to a cloud storage 132 (as discussed above) via communication path or communication link 130. Cloud storage system 132 may be used, inter alia, to store user profile information including a certain set of additional features being provided by IICS system or device 120 to a particular subscriber.

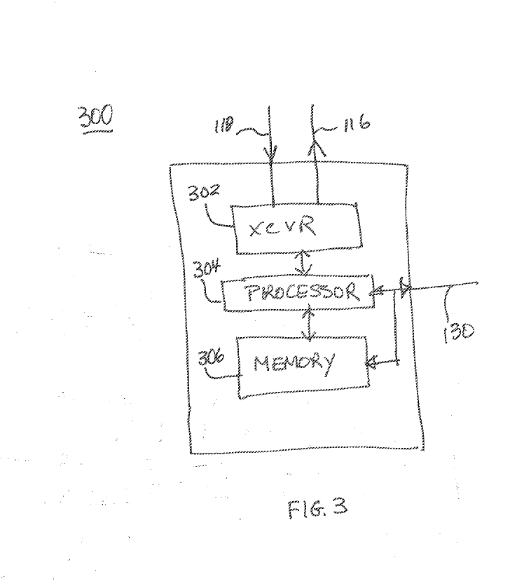

Referring now to FIG. 3, one embodiment of IICS 120 is shown comprising transceiver 302, processor 304 and memory circuit 306. Processor 304 is coupled to memory circuit 306 and transceiver 302. Communication links 118, 116 and 130 are not part IICS 120, but are shown for ease of explanation and consistency with FIG. 1. The processor 304 may be a microprocessor, microcontroller, desktop computer, laptop, server, a plurality of servers, or any combination of one or more of these different types of processors. The transceiver 302 comprises a transmitter circuit for transmitting signals and a receiving for receiving such signals. The receiver has appropriate gain characteristics and spectrum profile to be able to process the various received signals from the networks shown in FIG. 1. Processor 304 is able to process signals transmitted by the transmitter circuit (not shown) of transceiver 302 and also process signals received by the receiver (not shown) of transceiver 302. Processor is able to retrieve and store information extracted from received signals into memory circuit 306 and also store information into cloud storage 132 (see FIG. 1) via communication link 130. Further, processor 304 is able to control other communication equipment (not shown) in executing telephone call features requested by a subscriber to the services being provided by IICS 120.

Some of the features provided by IICS 120 include a PBX (Private Branch eXchange) feature, a call broadcasting feature, an ACD (Automatic Call Distribution) feature, an SMS (Short Message Service) logging feature, a telephone call conferencing feature, a call recording feature, a call whisper feature, a call barging feature, a phone operator log on/off feature, a MVNO (Mobile Virtual Network Operator) feature, an automatic voice transcription feature and a filtered DTMF feature. Some of the various features that are provided by IICS 120 are now discussed in some detail.

As stated above one of the features available from IICS 120 is the Private Branch Exchange feature where a subscriber of IICS is assigned a telephone number or can provide his/her own telephone number that can serve as a main number for a Private Branch eXchange (PBX). During the process of subscribing to IICS at a portal (e.g., internet site) provided by IICS 120, or updating his/her set of features services, a would be subscriber enters user profile information along with a phone number that he/she wants the IICS to use as a main number to a PBX service to be provided by IICS. Alternatively, the would-be subscriber may select the option to have IICS 120 generate the main number for the PBX associated with the subscribing user. Further, all of the telephone numbers that can be accessed by a calling party once having dialed the main number are part of a set of telephone numbers associated with the PBX; these telephone numbers can be provided by the would be subscriber or can be generated by the IICS along with labels for each such generated telephone numbers. For example, suppose a subscriber has subscribed to the PBX feature and provides a main telephone number to the IICS. Suppose, the main number is used by a subscriber as the main number to his/her business. Suppose further that a potential client of the subscriber would dial the main number and an automatic IICS voice can be generated guiding the caller through the various available numbers (e.g., phone number extensions). After the user selects the extension to which he/she wants to be switched, the IICS automatically calls that number. If no one answers at the extension number, the IICS gives the client an opportunity to leave a message at the main number or at the extension called or both. The main number generated by the IICS or provided to the IICS at the portal is associated with a set of numbers or extensions with the use of a mapping structure generated by IICS 120 and which can be updated by administrators of IICS or by the subscriber through the available portal. In short, the main number maps to a set of numbers (or extensions) to which a caller can be switched for assistance or service.

Another feature that can be provided by the IICS is a call broadcasting feature. A subscribing user (or a subscriber updating its user profile information and other feature information) can enter a telephone number identified as a broadcaster's number. When the subscriber dials this number, the IICS automatically confirms the identity of the mobile terminal (or telephone, IP telephone, legacy telephone) that dialed the number and also confirms that the identity of the operator of the mobile terminal. Listeners of the broadcast can listen to the broadcast at an IICS defined website or via their mobile phone (with a properly downloaded app from IICS). IICS provides at the portal the ability for listeners interested in broadcasts by subscribers of the features provided by IICS. The number dialed by the broadcaster (who is also a subscriber of IICS) is mapped to the link at which listeners can go to listen to the broadcast. The number dialed by the broadcaster can be generated by IICS, or the subscriber can provide such a number to IICS. IICS gives the subscriber the option to either enter his/her own broadcasting number or have IICS generate the number. At the portal, the broadcasting number is mapped to telephone numbers of individuals who have registered to listen to a scheduled broadcast by the subscriber. As the number of listeners change, the mapping changes accordingly.

Another feature that can be provided by the IICS is an automatic call distribution (ACD) feature, whereby IICS supports a set of telephone numbers for a commercial, private or governmental enterprise. Callers wanting a specific service will be instructed as to what keys to touch to gain access to certain services or information being provided by the enterprise. Any number from the set of numbers associated with the ACD that is dialed is automatically answered by the IICS and recognized by the IICS as a telephone number that is part of an ACD system. The caller is automatically answered and is given a list of options from which he/she selects. The caller is then instructed on how to obtain the information or service he/she desires.

Another feature provided by the IICS is the logging of incoming and outgoing texts in accordance with the short message service (SMS) protocol. The time at which SMS messages are received or transmitted for one or more subscribers of IICS who have this feature are logged and the a log of all the texts is provided by IICS to each such subscriber on an hourly basis, daily basis or any other time basis desired by the subscriber.

Yet another feature provided by the IICS is call conferencing. During an established telephone conversation between two more subscribers of the IICS any one or more of the subscriber parties to the telephone call can ‘conference in’ other parties. Parties who are subscribers and who were ‘conferenced in’ can themselves ‘conference in’ yet other parties. The number of levels to the phone conferencing is controlled by IICS. Regarding the levels of call conferencing, a call originally with two parties is at the first level. If one or both of the parties (who are subscribers) dials a request to conference in another party, the conferenced in party (and any other party conferenced in by one of the original parties) is at a second level. This can continue to several levels as provided by the IICS. Also, parties who are subscribers and who were one of the original calling party or called party can pay for a certain amount of levels of conferencing. Subscribers who have the call conferencing feature may, at any time, during an established telephone dial a “call conferencing request” by touching a defined sequence of keys set by the IICS as the command for ‘call conferencing.’

Yet another feature provided by the IICS is call recording. Subscriber of IICS may, during an established telephone call, input a command requesting that the telephone call be recorded. The command may be a series of touches made by the subscriber, which is recognized by the IICS as a recording command. The recording command and any other feature requests are defined by the IICS.

The IICS also provides a call whisper feature, where signals (transmitted or received) by parties to an established telephone call can be duplicated and routed to other signal processing equipment associated with the IICS as needed. The conversation between the parties to a telephone call looped back through the IICS can be monitored. A subscriber can, at any time, during the established telephone call can

Another feature made available by the IICS is the call barging feature whereby an established telephone call looped back through the IICS can add a party to the conversation without the consent of the original parties to the call. The added party, similar, to a conference call is able to communicate with all of the original parties to the telephone call.

For certain organizations or enterprises that employ telephone staff (i.e., telephone operator) who answer telephones for various services being offered by the organization or enterprise, there is often a need to document the hours worked by each telephone operator. Owners of these enterprises can subscribe to the log On/Off feature where each telephone number of an employee is generated by IICS. Whenever an employee starts his/her working day that employee can dial in a login request and the IICS will record, for that day, the login time of that employee. The same process can be done when the employee wishes to log out for the day; the employee touches a series of DTMF keys equaling the log off request and the IICS records the log off time for that employee.

Another feature available from the IICS is automatic voice transcription. Subscribers who may be hard of hearing can subscribe to this feature so that from the beginning of a telephone conversation between the subscriber (presumably is hard of hearing or deaf) and another party, the isolated transmissions of the party is fed to an automatic audio transcription machine, which converts the speech into text, which is transmitted along with the speech to the telephone (e.g., IP telephone, mobile terminal and other phones with text receiving capabilities) of the subscriber. The telephone number of the hard of hearing party is mapped to this feature and the transcription is performed automatically without the hard of hearing party having to request for transcription services by entering a transcription request. Alternatively, only the text signals are sent to the hard of hearing party and the voice signals are not sent. Thus the hard of hearing party receives the text, but can speak his/her responses to the other party. In another embodiment of this automatic voice transcription, the automatically generated text is reviewed by a human operator at a call center associated with the IICS prior to its transmission to the hard of hearing party. The human operator may correct any spelling errors or other errors that may occur in the automatic transcription. In yet another embodiment, the subscriber may select (at the portal—when entering user profile information and features selected) to have the transcription be done automatically or be initiated after the subscriber enters a subscription command (as defined by the IICS at the portal) for voice transcription. In response to the command (which is done using the DTMF keys of the telephone of the subscriber), the IICS may generate a text response to the phone of the subscriber, the text response may be, for example, “voice transcription activated.” The subscriber may also have a command (also generated by DTMF key touches or depressions) to deactivate the voice transcription whereby when such a command is entered by the subscriber, the IICS generates a response, for example, as “voice transcription deactivated.” Also, the transcriber may remove his desire to have voice transcription by entering (or not entering) the appropriate information for the activation of voice transcription.

Another feature in which the subscriber may control via commands (defined and generated by the portal of the IICS at which the subscriber enters user profile information) is that amplification or attenuation of the voice signals being transcribed. Thus during the telephone call in which the subscriber may or may not be receiving transcribed text, the subscriber may touch a defined combination of DTMF keys to indicate his/her desire to have the voice signals destined for his phone amplified by a certain amount. Each time the subscriber sends the amplification command, the voice signals are amplified by a certain amount. The same approach can be done if the subscriber desires to have the voice signals attenuated. Each time the subscriber touches (or dials) the command for attenuation or amplification, the IICS will attenuate amplify the voice signals by a certain predefined amount. For example, if each touch to amplify or attenuate is 0.1 dB, 5 consecutive commands for attenuation or amplification will cause the IICS (equipment involved with the transcription of voice) to amplify or attenuate the voice signals by 0.5 dB. The IICS will provide a certain range of attenuation and amplification. The ranges may be the same or different from each other.

With many of the above-described features and other similar features not discussed above, one of the parties has to touch a series of DTMF keys on their communication device to request a particular feature. There are certain features, which are executed by the IICS automatically without needing to receive a feature request command in the form of a sequence of DTMF keys. Examples of such features are the call broadcasting feature where the telephone number dialed automatically maps to the initiation of the call broadcasting procedure. Another automatic feature is the PBX feature whereby the number dialed represents a main number of a PBX procedure. Automatic features that are executed immediately after the IICS receives a call established signal allowing the IICS access to an established telephone call are referred to as commencement telephone call features. The IICS having access to an established telephone call refers to a call being routed to the IICS allowing the IICS to separate (or isolate from each other) the transmit and receive signals of each of the parties to the established telephone call and process (e.g., amplify, filter, inject generated signals) some or all of the different isolated signals as needed to execute one or more telephone call features including commencement, automatic telephone call features.

One example of the processing of a routed established telephone call is the ability of the IICS to filter out the resulting audio tones when one of the parties to an established telephone call dials or touches a sequence of DTMF keys to generate a command to and through the IICS. The command may be a request for a certain feature as discussed above. As discussed previously each party to an established telephone call that is looped back through the IICS has its transmitted signals and received signals isolated from each other. The transmitted signals may be, for example, the words spoken by a party and the received signals are the audio signals, for example, being heard by the party. Another feature of the IICS is to filter out the resulting DTMF tones when a subscriber party, for example, dials a feature request or command. IICS receives the command by monitoring the isolated transmissions of all parties for DTMF tones. IICS receives these DTMF tones and processes them to determine if they represent a defined command, and if so, executes the command accordingly. With this feature, however, the IICS also filters out the generated DTMF tones preventing such tones to be received by the listening party. In many cases, the party who has not generated a feature request is not a subscriber and therefore, need not hear the DTMF tones. In another embodiment, even if the non-requesting party is a subscriber, IICS filters out the DTMF tones anyway. The DTMF tones are filtered out using, for example, well known digital or analog filtering techniques.

Returning to FIG. 1, temporarily, a telephone call looped back through IICS 120 may have both the calling party and the called party as subscribers to the interconnected networks 102, 104 and 106 as shown. The interconnected networks may be owned, controlled and operated by different entities who have agreed to comply with the same standards and corresponding protocols and share in providing service to users either by contract or by governmental regulating bodies. That is, an interconnected network may provide services to users who are not its subscribers, but who are subscribers to a cooperating interconnected networks. IICS 120 is shown coupled to interconnected networks 102, 104 and 106 and is also coupled to non-interconnected networks 122 and 124. Any user who is a subscriber to any one of the interconnected networks is able to originate a call to the non-interconnected networks through IICS 120. IICS 120 can be equipped with a communication switch (not shown) to enable it to route calls between an interconnected network and a non-interconnected network. Thus, any subscriber of networks 102, 104 and 106 can route a telephone to a non-interconnected network (e.g., networks 122, 124) using a communication switch (not shown) coupled to or integral with IICS 120. Communication links 126 and 128 are coupled to the communication switch (not shown) of IICS 120. In this manner IICS 120 (equipped with a communication switch) can operate as a MVNO (Mobile Virtual Network Operator), which has access to both the interconnected networks and the non-interconnected networks. A call originating from a subscriber of one of the interconnected networks and also a subscriber of IICS can be routed to one of the non-interconnected networks by IICS 120 for a much lower rate than if the call were routed by an interconnected network. In this manner, subscribers of IICS 120 are able to originate calls and receive calls from non-interconnected networks (e.g., overseas networks) at relatively low cost.

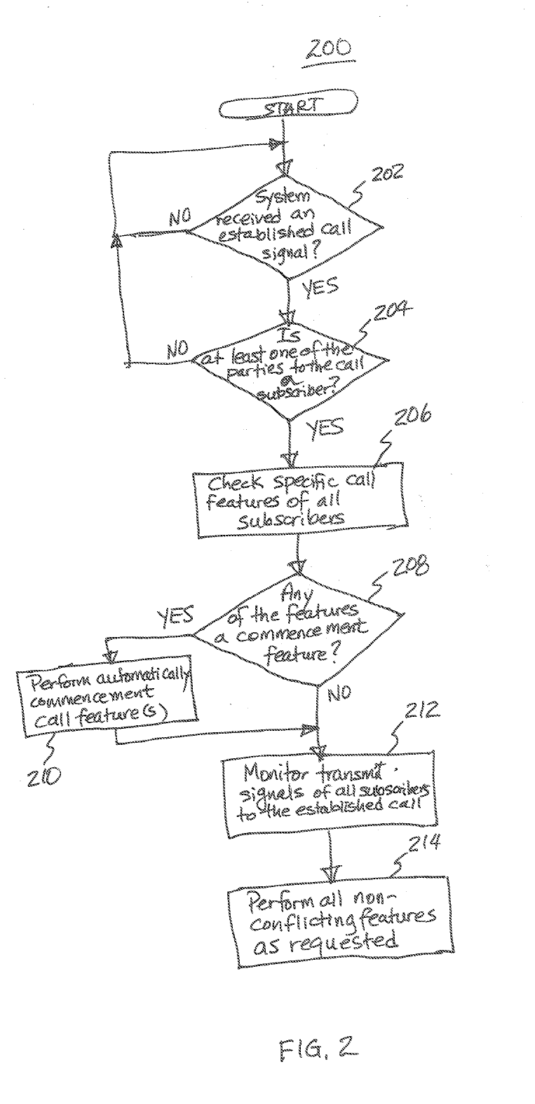

Referring now to FIG. 2, which shows a method of the present disclosure performed by IICS 120 of FIG. 1. First, a call is established between two communication devices being serviced by the same or different networks in accordance with the proper protocols of one or more communication standard being followed by the network(s) involved. A signal indicating an established call where at least one of the parties to the call is a subscriber to IICS 120 and its services, is transmitted to IICS 120. IICS 120 allows a loopback to be established. The loopback refers to the signals (data information and signaling information) of the call being received and processed by IICS 120 and the processed signals are routed back to the network equipment from which they came. The processed signals are then routed between the parties in a communication session (e.g., a telephone call) in accordance with the pertinent communication protocols. The discussion that follows describes one embodiment of the steps performed by IICS 120 in providing the various features discussed above.

In step 202, IICS 120 receives a signal indicating that an established call is about to be routed and looped back through IICS 120. Part of the information received by IICS 120 may include the telephone numbers (or other information identifying the user communication equipment involved in the call) of the mobile terminals or telephones involved in the established call. Further, the information received by IICS 120 indicating that an established call is about to be routed through IICS 120 may also include other information certifying that at least one of the parties to the established call is a subscriber to a network that provides the additional features available from IICS 120. Referring momentarily to FIG. 1, entry network 114 provides additional features that are executed by IICS 120 for subscribers of entry network 114 who have also subscribed to the additional features. As described previously, subscribers of entry network 114 may be located at various locations where they are served either by network 114 or by other networks that are interconnected to network 114. Thus, continuing with our example, a subscriber of network 114 that is located in a geographical area serviced by, for example, interconnected network 102 will be able to have a call established by network 114 or at least network 114 equipment (i.e., communication switch of network 114—not shown) will be informed of such an established call.

In step 204, if none of the parties to the established call is a subscriber of IICS 120, then the method of the present disclosure does not perform any of the special features and continues to monitor for any established call signal. Such an occurrence may be where at least one of the subscribers is a client of network 114, but has not subscribe to the additional features offered by IICS 120. However, if at least one of the parties to the established call is a subscriber of IICS, then the method of the present disclosure moves to step 206. It should be noted that all subscribers to the features being offered by IICS 120 have their user profile information and their equipment identification number ((Mobile Identification Number (MIN); Mobile Station ID (MSID); IMEI (International Mobile Equipment Identity)), or their telephone number stored in the memory circuit 306 (or cloud storage 132) of IICS 120. Any of the aforementioned IDs or telephone number can be used to identify that a party to the telephone call is a subscriber to IICS 120 and the additional features it provides. Depending on the circumstances of the particular established telephone call, there can be more than one party to the telephone call who is also a subscriber of the additional features provided by IICS 120.

In step 206 upon receipt of the signal from entry network 114 (most likely from a communication switch of the entry network), the IICS determines which of the user communication equipment (e.g., mobile terminal, IP telephone) that is a party to the telephone call is a subscriber to the services being provided by IICS 120. Any party (or the party's communication equipment) to the telephone call who has already subscribed to the telephone call features being provided by IICS 120 would be listed in the memory circuit of IICS 120 or would have entered user profile information as well as communication device identification while subscribing or updating their information at the portal provided by IICS 120; such a portal would be part of cloud storage 132 as shown in FIG. 1, but may also be part of another server coupled to IICS 120 that contains a publicly available site serving as a portal to subscribers and would-be subscribers to IICS 120. Further, IICS determines which specific features are applicable to the established telephone call. As discussed above, these specific features are associated with the subscriber parties to the telephone call. Such telephone call features would have been entered (or updated, as the case may be) by subscribers at the portal provided by IICS 120.

In step 208 IICS 120 determines whether any of the features applicable to the telephone call is a commencement feature. As previously explained a commencement feature is one that is executed at the beginning of a communication session under conditions defined by the IICS 120; many such features are executed automatically by the IICS. In particular, if any of the parties to the telephone call is a subscriber of the IICS who has as part of his/her set of features a commencement feature, the IICS will automatically execute that commencement feature in step 210 for all such subscribers. That is, in step 210 the IICS will execute all applicable non-conflicting commencement features to effectuate meaningful communication between the parties to the communication session (e.g., a telephone call). The IICS will The parties to the telephone call who are subscribers of IICS 120.

If, on the other hand, none of the parties to the telephone call is a subscriber having at least one commencement telephone call features as part of his/her set of features, the method of the present disclosure moves to step 212.

In step 212, during communications between the parties to the telephone call, processor 304 controls the flow of communication signals from the various parties of the telephone call by separating the signals being received and signals being transmitted by each of the parties from each other and from any other signals. For example, if there are two parties to the telephone call—a calling party and a called party—each party has two signal flows; a transmission flow and a receiving flow. The communication equipment of the calling party has a transmit signal flow and a receive signal flow. The equipment of the called party also has a transmit and receive signal flows. That is, for each party, the signals transmitted from a microphone of their communication equipment are separated from the signals received by the speaker of their communication equipment. After the separation of each party's transmission signals and reception signals, processor 304 of the IICS can monitor the transmit signal flows for each of the communication equipment of a subscriber. In another embodiment, processor 304 of IICS 120 monitors the transmit signal flows for all of the communication equipment regardless of whether such equipment are subscriber equipment or not.

In step 214, when processor detects a feature request by determining that a sequence of DTMF keys corresponds to a request for a defined feature, it does the following: first, it generates a response to the request to the equipment from which the request originated to acknowledge reception of the request. The response can be in the form of beeps, tones, or pre-recorded audio response. Second, the processor controls and operates the transceiver, memory circuit and any other circuit or equipment (not shown) to execute any one or all non-conflicting features. Executing the feature means the processor performs the necessary steps to perform the particular type of processing, at the appropriate time and for the appropriate duration of time, of signals transmit signals or received signals or both of the requesting communication equipment. Some of the features executed may be commencement features, or automatic commencement features; all executed features are non-conflicting features. If a requested features conflicts with another feature being executed or a feature that has already been executed, processor 304 sends a message to the communication equipment (e.g., mobile terminal) that transmitted the request. The message would first inform the communication equipment that the requested feature cannot be executed and invite the communication equipment to make another request.

The particular embodiments disclosed above are illustrative only, as the disclosed subject matter may be modified and practiced in different but equivalent manners apparent to those skilled in the art having the benefit of the teachings herein. It will be apparent to persons skilled in the relevant art (s) that various changes in form and detail can be made herein without departing from the spirit and scope of the various example embodiments discussed herein. No limitations are intended to the details of construction or design herein shown, other than described in the claims below. It is therefore evident that the particular embodiments disclosed above may be altered or modified and all such variations are considered within the scope of the disclosed subject matter. Thus, this description of various embodiments should not be limited by any of the above-described exemplary embodiments, but should be defined only in accordance with the following claims and their equivalents. Accordingly, the protection sought herein is as set forth in the claims below.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above-described exemplary aspects, but should be defined only in accordance with the following claims and their equivalents.

In addition, it should be understood that the figures in the attachments, which highlight the structure, methodology, functionality and advantages of this disclosure, are presented for example purposes only. This disclosure is sufficiently flexible and configurable, such that it may be implemented in ways other than that shown in the accompanying figures.

What is claimed is:

1. An apparatus comprising:
at least one transceiver;
at least one memory circuit; and
at least one processor coupled to the at least one transceiver and the at least one memory circuit, whereupon the apparatus receiving access to an established telephone call, the at least one processor executes automatically one or more commencement telephone call features based on selected features associated with the telephone call and the processor monitors transmitted signals from the established telephone call to execute non-conflicting telephone call features in response to received feature requests.

2. The apparatus of claim 1 where access to the established telephone call is received via a loopback configuration.

3. The apparatus of claim 1 where conflicting and non-conflicting features are defined by a data structure stored in the memory circuit.

4. The apparatus of claim 1 where telephone call feature requests received from a non-subscriber mobile terminal are filtered out by the processor.

5. The apparatus of claim 1 where conflicting telephone call feature requests received from a subscriber mobile terminal are filtered out by the processor.

6. The apparatus of claim 1 where the processor isolates transmitted signals and received signals received from subscriber mobile terminals.

7. The apparatus of claim 6 where the processor monitors the isolated transmitted signals to determine whether a telephone call feature request was transmitted.

8. The apparatus of claim 7 where the feature request is a string of DTMF signals received from a subscriber mobile terminal.

9. The apparatus of claim 1 where the automatic telephone call feature is a PBX feature.

10. The apparatus of claim 1 where the automatic telephone call feature is call broadcasting.

11. The apparatus of claim 1 where the non-conflicting telephone call feature is an automatic call distribution.

12. The apparatus of claim 1 where the non-conflicting telephone call feature is SMS logging.

13. The apparatus of claim 1 where the non-conflicting telephone call feature is a telephone call conferencing.

14. The apparatus of claim 1 where the non-conflicting telephone call feature is telephone call recording.

15. The apparatus of claim 1 where the non-conflicting telephone call feature is call whisper.

16. The apparatus of claim 1 where the non-conflicting telephone call feature is call barging.

17. The apparatus of claim 1 where the non-conflicting telephone call feature is log on and log off documentation.

18. The apparatus of claim 1 further comprising a cloud storage system coupled to the at least one memory.

19. The apparatus of claim 18 where a portion of the cloud storage system includes a portal accessible via a public network and through which users subscribe to services provides by the apparatus.

20. The apparatus of claim 19 where the public network is the Internet.

21. The apparatus of claim 18 where a portion of the cloud storage includes a portal accessible via a public network and further where previously entered subscriber information are updated by said subscribers.

22. The apparatus of claim 1 further comprising a communication switch.

23. The apparatus of claim 22 where the communication switch routes the established telephone call from an interconnected network to a non-interconnected network.

24. The apparatus of claim 23 where the established telephone call is routed via the Internet.

25. A method comprising:
monitoring, by an IICS, for received transmit signals of an established communication session to determine if at least one feature request has been transmitted; and
executing the at least one requested feature after confirming that said at least one requested feature is non-conflicting.

26. The method of claim 25 where the step of monitoring comprises:
receiving, by the IICS, an established call signal; and
determining, by the IICS, whether at least one of the parties to the established call is a subscriber to services provided by the IICS.

27. The method of claim 25 where the established communication session is an established telephone call.

28. The method of claim 25 where the IICS isolates transmit signals of each party to the communication session and the IICS also isolates signals received by each party to the communication session.

29. The method of claim 25 where the IICS where the received signals are from communication equipment of a communication network to which IICS is coupled.

30. The method of claim 29 where the communication network is an interconnected communication network.

31. The method of claim 29 where the IICS is coupled to the communication network via a loopback connection.

32. The method of claim 25 where the received transmit signals monitored for by the IICS are keyed sequences of DTMF tones of a communication equipment of an IICS subscriber.

33. The method of claim 25 where the step of executing the at least one feature comprises executing a commencement feature.

34. The method of claim 25 monitoring by the IICS comprises first determining whether there are any commencement features and executing automatically any found commencement features.
